(19) United States
(12) Patent Application Publication
(10) Pub. No.: US 2026/0221712 A1
(43) Pub. Date: Jul. 30, 2026

(54) Hybrid Amplifier for Laser Fusion

(71) Applicant: LaserFusionX, Inc., Springfield, VA (US)

(72) Inventor: Malcolm McGeoch, Little Compton, RI (US)

(21) Appl. No.: 19/446,213

(22) Filed: Jan. 12, 2026

Related U.S. Application Data
(60) Provisional application No. 63/749,331, filed on Jan. 24, 2025.

(51) Int. Cl. H01S 3/23; H01S 3/00; H01S 3/109; H01S 3/225

(52) U.S. Cl. CPC H01S 3/2375; H01S 3/0057; H01S 3/109; H01S 3/2251; H01S 3/2308; H01S 2301/02

(57) ABSTRACT

A hybrid laser amplifier system comprises a low-energy front end providing frequency-multiplied laser pulses, a transfer medium that can convert the frequency-multiplied laser pulses at a first wavelength to a second wavelength that can experience gain in a high-energy back end of the laser amplifier system. The high-energy back end can comprise one or more excimer amplifiers.

### CROSS-REFERENCE TO RELATED APPLICATIONS

The present application claims a priority benefit, under 35 U.S.C. § 119(e), to U.S. provisional application Ser. No. 63/749,331, filed on Jan. 24, 2025, titled “Hybrid Amplifier for Laser Fusion” which provisional application is incorporated by reference herein in its entirety.

### BACKGROUND

The first publication relating to power generation by laser fusion was the stimulus for a rapidly increasing research effort toward that goal. (J. Nuckolls et al., “Laser compression of matter to super-high densities: Thermonuclear (CTR) applications”, Nature 239, 139-142 (1972)) Initially it was thought that the laser could compress and heat a target containing deuterium and tritium when directly focused on its surface, an approach known as “direct-drive” laser fusion. It was realized after several years of experimentation with different laser wavelengths that the direct-drive process would only be stable for very short wavelength lasers, ruling out, for example, CO₂ lasers at 10.6 microns, iodine lasers at 1.3 microns, and even the Nd laser wavelength of 1.06 microns. Later in the 1970s, gas excimer lasers such as krypton fluoride (KrF, at 249 nm) and argon fluoride (ArF, at 193 nm) were discovered and intensively researched. By the early 1980s the dust had settled, as it were, in that essentially only two laser types, gas excimer and frequency-tripled Nd lasers (at 351 nm) appeared viable in the role of driver - a situation that remains true up to the present day.

Under the high average power laser (HAPL) program, from 1999 until 2009, the leading exemplars of each type were tested and achieved a promising level of repetition rate operation (1 Hz-10 Hz) at the 0.1 kJ-1 kJ range of energies, with plausible avenues to 0.1-1 MJ energy levels and life extension to the region of 1 billion pulses, the requirements for laser direct-drive fusion. (J. D. Sethian et al., “The Science and Technologies for Fusion Energy with Lasers and Direct-Drive targets”, IEEE Trans. Plasma Sci. 38, 690-703 (2010)) During this whole period a deeper understanding of the effects of wavelength and laser bandwidth on plasma stability was gradually achieved, first summarized by Bodner et al. and updated in a review by Craxton et al. (S. E. Bodner et al., “Direct-Drive Laser Fusion; Status and Prospects”, Phys. Plasmas 5, 1901-1918 (1998); R. S. Craxton et al., “Direct-drive inertial confinement fusion: A review”. Phys. Plasmas 22, 110501 (2015))

For stable compression in direct drive, the laser wavelength should be 351 nm or less, and the laser should apply a broad range of frequencies, up to 10 THz, around a central wavelength. For the ArF laser at wavelength 193.3 nm (frequency 1551 THz), amplifier chains delivering greater than 60 kJ can generate greater than 10 THz bandwidth, thereby enabling, when employed in multiples at a total energy of 500 kJ, a theoretically stable compression that achieves a gain of up to 150, defined as fusion energy emitted divided by laser energy applied. (S. P. Obenschain et al., “Direct drive with the argon fluoride laser as a path to high fusion gain with sub-megajoule laser energy”, Phil. Trans. Roy. Soc. A378, 20200031 (2020); A. J. Schmitt and S. P. Obenschain, “The importance of laser wavelength for driving inertial confinement fusion targets. II. Target design”. Phys. Plasmas 30, 012702 (2023)) The target design comprises a spherical polymer shell of diameter about 3 mm that encloses a foam layer impregnated with frozen D-T fuel and has an external gold or platinum coating to reflect heat during target entry into the reactor chamber. Equally important, the thin metal layer emits a burst of X-rays in response to the first part of the laser pulse, enabling much improved plasma initiation uniformity and subsequent uniform compression.

Although the final stages of a fusion laser can include ArF amplifiers, so as to deliver highly effective target compression and ignition (R. Betti et al., “Shock ignition of thermonuclear fuel with high areal density”, Phys. Rev. Lett. 98, 155001 (2007)), the earlier stages in an ArF laser system can become cumbersome owing to the use of about 100 separate laser beamlets that pass in sequence through each of its electron-beam-pumped amplifiers in a process known as angular multiplexing (J. J. Ewing et al., “Optical pulse compressor systems for laser fusion”, IEEE J. Quantum Electron. QE-15 368-379 (1979); Obenschain et al., “High energy krypton fluoride lasers for inertial fusion”, Appl. Opt. 54, F103-F122 (2015)). These beamlets are un-correlated so as to avoid speckle patterns and non-uniformity when superimposed on a target surface.

Photon-induced dissociation of Ar₂F* at 248 nm produces ArF* with 100% quantum efficiency. (K. Hakuta et al., “Photoabsorption cross section measurement of Ar2F excimer at 248 nm”, J. Opt. Soc. Am. B5, 1261-1265 (1988)) Potential energy curves for the ArF-Ar₂F system have been calculated and list a range of different dissociation pathways, the strongest of which is the Ar₂F (4²Γ−>9²Γ) transition with a calculated peak wavelength of 319 nm. (W. R. Wadt and P. J. Hay, “Electronic states of Ar2F and Kr2F”, J. Chem. Phys. 68, 3850-3863 (1978)) This dissociation path is depicted in FIG. 1.

### SUMMARY

The present technology relates to the architecture of a high-energy (greater than 0.3 MJ) laser that has final stages emitting argon fluoride (ArF) radiation in the deep ultraviolet at 193 nm. This is a short wavelength for efficient lasers (greater than 10% efficiency) and the ArF laser bandwidth is at least 10 THz, both factors which are desirable for the stable compression and ignition of a fusion target. Further advantages of this gaseous laser medium over solid state lasers are a) the gas medium is not damaged by repetitive high intensity optical pulses, and b) the whole optical system of this type of laser has a very small thickness of solid state optical material in the laser train at high optical power and hence very high intensity pulses can propagate without destructive self-focusing that could be caused by the nonlinear index of refraction in solid state optical materials.

Some implementations relate hybrid laser amplifier systems. Such systems comprise: a diode-pumped solid-state laser to emit pulsed laser radiation; a frequency multiplier optically coupled to the diode-pumped solid-state laser to convert a wavelength of the pulsed laser radiation to a first wavelength of first optical pulses; a transfer medium optically coupled to the frequency multiplier and arranged to receive the first optical pulses and output second optical pulses; and an electron-beam-pumped excimer amplifier optically coupled to the transfer medium and arranged to receive the second optical pulses and output amplified optical pulses. The transfer medium can convert a first wavelength of the first optical pulses to a second wavelength of the second optical pulses that will experience gain in the electron-beam-pumped excimer amplifier. Additionally, the transfer medium transfers a spatial intensity profile and temporal pulse duration of the first optical pulses to the second optical pulses.

Some implementations relate to methods of producing pulses of amplified spontaneous emission for amplification by an excimer amplifier. Such methods can include acts of: emitting, by a diode-pumped solid-state laser, pulsed laser radiation; receiving, by a transfer medium optically coupled to the diode-pumped solid-state laser, first optical pulses produced by the pulsed laser radiation; converting, by the transfer medium, the first optical pulses at a first wavelength to second optical pulses at a second wavelength that will experience gain in the excimer amplifier; and transferring, by the transfer medium, a spatial intensity profile and temporal pulse duration of the first optical pulses to the second optical pulses.

All combinations of the foregoing concepts and additional concepts discussed in greater detail below (provided such concepts are not mutually inconsistent) are part of the inventive subject matter disclosed herein. In particular, all combinations of subject matter appearing in this disclosure are part of the inventive subject matter disclosed herein. The terminology used herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally and/or structurally similar elements).

FIG. 1 depicts the potential energy curves for the di-argon fluoride excited molecular states and the dissociation path to the argon fluoride upper laser level of the hybrid laser amplifier system.

FIG. 2 is a simplified depiction of a hybrid laser amplifier system for driving fusion reactions, showing a DPSSL front end, a transfer medium, and an output, electron-beam-pumped argon fluoride excimer amplifier.

FIG. 3 depicts the use of multiple angularly coded beamlets to extract energy from an electron-beam-pumped argon fluoride amplifier.

### DETAILED DESCRIPTION OF THE INVENTION

It is challenging for a “front end” set of discharge-pumped ArF lasers to provide the desired quality of un-correlated beamlets prior to amplification due to both longitudinal and transverse non-uniformity in discharge laser mode structure. It would be prohibitively expensive and space-consuming to employ 100 ArF discharge lasers and difficult to keep these in balance, with always the desired pulse shape. The present technology employs in place of a multiplicity of ArF oscillators at least one solid-state laser of moderate energy based upon rare-earth ions either in glass or crystal, pumped by laser diodes (referred to as a diode pumped solid state laser, or DPSSL). Its output can be frequency tripled to 351 nm, or a close-by wavelength. This output can be narrow-band, with excellent spatial quality and can be split reliably to create multiple beamlets. These ultraviolet “UV” beamlets at 351 nm would all have correlated phases, but this would not matter in view of the next step. In the next step, the UV beamlets at 351 nm enter an electron-beam-pumped argon fluoride excimer gain region and are absorbed to create beamlets of 193 nm amplified spontaneous emission (ASE) via the dissociation of Ar₂F* molecules. Although the UV pump beams have phase correlations, because of incoherence in Ar₂F* dissociation those do not carry through into the resulting ArF* ASE beamlets. After a gain length for amplification of spontaneous emission the exiting 193 nm ASE beamlets are uncorrelated, and un-polarized, thereby offering smoothing when they are later superimposed at a target surface. Modeling shows that spatial and temporal properties (e.g., spatial intensity profile, pulse duration) of the entering UV pump beams are transferred to the amplified spontaneous emission beamlets as described in M. McGeoch and S. Obenschain “Argon fluoride laser system for high gain direct drive fusion” Optics Express 33, 48423-48450 (2025) at section 2.4.2 for example, which publication is incorporated herein by reference in its entirety. However, the newly created 193 nm spontaneous emission beamlets have a large bandwidth characteristic of ArF emission (e.g., from approximately or exactly 3 THz up to approximately or exactly 15 THz) without any relation to the narrower bandwidth of the injected UV beamlets.

The formation of Ar₂F occurs both directly and indirectly in electron beam excited argon fluorine mixtures. If the optical intensity at 193 nm is low, then ArF*, the upper laser level, is complexed by three-body association into Ar₂F* at an energy only 0.6 eV below ArF*. Modeling shows that dissociation by a UV pulse pulse with high contrast to background will generate contrast of up to about 1,000 in the new 193 nm ASE beamlets, and tunable pulse durations from 0.1 ns- 2 ns.

The present technology includes a hybrid laser amplifier system to drive fusion reactions. The hybrid laser amplifier system generates, in its high-energy output sections, argon fluoride (ArF) 193 nm radiation, having desirable laser-target interactions. The low-energy “front end” of this system uses the versatility and reliability of diode-pumped solid state rare-earth/glass or crystal lasers (DPSSLs) for input to a transition amplification medium that creates high numbers of 193 nm spontaneous emission beamlets for angular multiplexing in the high-energy ArF amplifiers.

The transition amplification medium, or transfer medium, is an electron-beam-pumped argon/fluorine mix. Typically, this comprises 1-2 amagats of argon with 0.5% fluorine. Before entering the transfer medium, the DPSSL laser pulses are converted by third harmonic generation, or other non-linear processes, into light with wavelengths of approximately 320 nm (“UV” light) which upon entering the transfer medium dissociates Ar₂F* excited state molecules to produce ArF* upper laser states. The resulting travelling gain wave amplifies ArF 193 nm spontaneous emission to create pulses that have spatial and temporal properties molded by those of the incoming 320 nm beams. The conversion of wavelength and the transfer of spatial and temporal properties from the received UV pulses to the outgoing 193-nm pulses occurs simultaneously in the transfer medium along with the decorrelation and depolarization for subsequent smoothing when superimposed at the target. Up to 100 or more beamlets are used for angular multiplex energy extraction in the electron-beam-pumped ArF amplifiers, and beneficially this transfer process generates uncorrelated, unpolarized, beamlets for smoothing at the fusion target surface. Smoothing is desirable to reduce non-uniformity that otherwise can degrade an implosion of the fusion target.

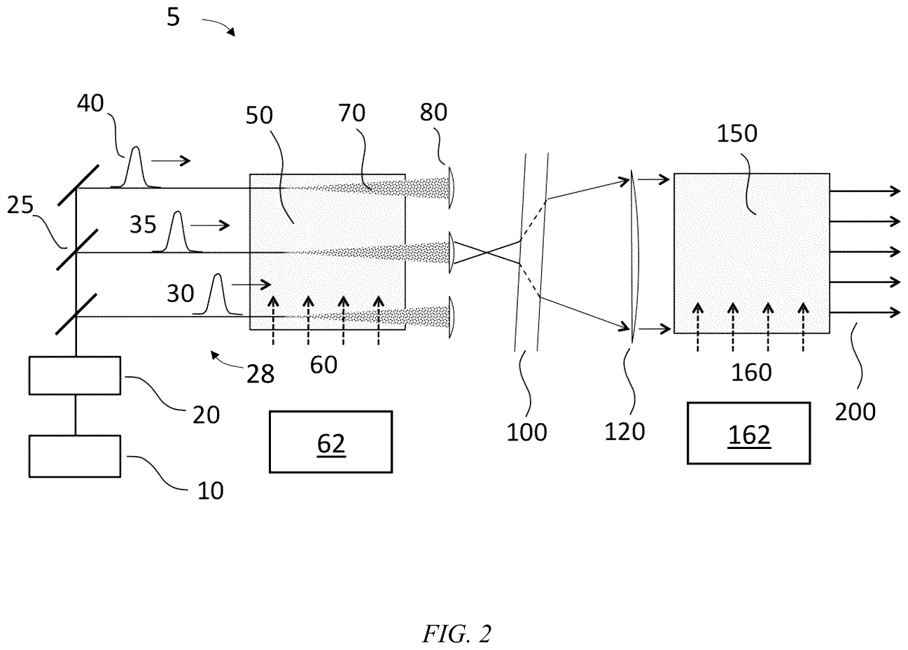

FIG. 2 depicts an example of a hybrid laser amplifier system 5. The hybrid laser amplifier system 5 comprises a diode-pumped solid-state laser 10 optically coupled to a frequency multiplier 20 that, in turn, is optically coupled to a transfer medium 50 that, in turn, is optically coupled to an excimer amplifier 150. Two components that are “optically coupled” indicates that an optical path through the hybrid laser amplifier system 5 passes through and/or interacts with the two components. Two components can be optically coupled together with one or more mirrors, lenses, or other optical elements between the two components to steer and/or shape an optical beam traveling along an optical path between the two components. The diode-pumped solid-state laser 10, at the low-energy front end of the system, can emit laser radiation at approximately 1 μm wavelength (e.g., from 900 nm to 1200 nm) in pulse durations that can be fixed or varied from 0.1 nsec to 10 nsec. These pulses are frequency multiplied (e.g., frequency tripled) to a wavelength band in the region of 300 nm to 400 nm in frequency multiplier 20 which may contain at least one KDP crystal or other optically nonlinear crystal. In some cases, the wavelength band has a central wavelength at approximately or exactly 351 nm. Pulses from the frequency multiplier 20 can be divided by beamsplitters 25 into a multiplicity of UV beamlets 28 comprising optical UV pulses 30, 35, 40 that enter the transfer medium 50. The UV beamlets 28 can enter the transfer medium 50 parallel to each other, at an angle with respect to each other, or a combination of parallel and angled entry directions.

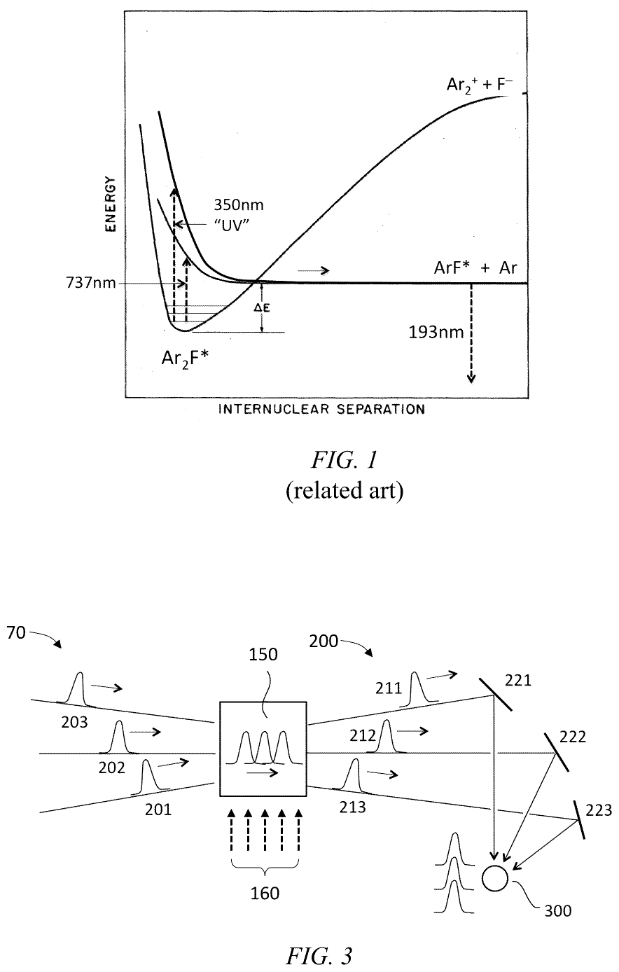

The transfer medium 50 comprises a volume of argon/fluorine laser gas mix pumped by first electron beams 60 from one or more electron-beam source(s) 62. The transfer medium 50 converts a first wavelength of the incoming UV pulses 30, 35, 40 to a second wavelength that will experience gain in the downstream electron-beam-pumped excimer amplifier 150 at the high-energy back end of the laser amplifier system 5. The incoming UV pulses 30, 35, 40 dissociate Ar₂F* (di-argon fluoride) molecules (see FIG. 1) and the resulting ArF* molecules radiate spontaneous 193 nm light, which grows in energy forming ASE beamlets 70 that each travel in synchronism with the UV pulses 30, 35, 40. For example, the spontaneous emission at 193 nm is amplified by the gain available in the transfer medium 50 at that wavelength. In some cases, the transfer medium 50 comprises a mixture of argon, krypton, and fluorine that generates di-krypton fluoride excited state molecules.

With reference to FIG. 2, the generated ASE beamlets 70 can be operated on by beamlet lenses 80 to change the size of each beam waist and re-collimated with a collimating lens 120 before entering at least one excimer amplifier 150. There can be a plurality of excimer amplifiers 150 arranged in parallel to amplify the ASE beamlets 70. One or more ASE beamlet(s) 70 can be amplified by one excimer amplifier 150. Only one excimer amplifier is shown in FIG. 2. The excimer amplifier(s) 150 can comprise an argon fluoride gas and be pumped by second electron beams 160 from one or more second electron-beam sources 162, which may be pulsed. A break 100 is drawn in FIG. 2 to represent beam expansion which can occur by propagation of the ASE beamlets 70 through free space and/or with additional beam-expansion optics (e.g., diverging or negative lenses). Although only one of the ASE beamlets 70 is shown entering the excimer amplifier 150, each beamlet 70 can be directed through the excimer amplifier 150. In some cases, the ASE beamlets 70 can propagate through the transfer medium at different angles such that the beamlets 70 can all proceed through the beamlet lenses 80 and the excimer amplifier 150. Multiple amplified beamlets 200 (with wavelengths of 193 nm) can emerge at high energy from the excimer amplifier 150. In some cases, the amplified beamlets 200 can propagate at slightly different angles (angular multiplexing) due to their different incidence locations and/or incident angles on the collimating lens 120.

FIG. 3 depicts pulse amplification and angular multiplexing of the pulses. The ASE beamlets 70 (indicated as pulses 201, 202, 203) are incident on the excimer amplifier 150. The pulses 201, 202, 203 are received in the excimer amplifier 150 from different angles. The pulses 201, 202, 203 can be received from the collimating lens 120 of FIG. 2, for example. The excited upper state for the argon/fluoride gain medium in the excimer amplifier 150 can have a lifetime of only a few nanoseconds (nsec) before decaying by spontaneous emission and collisional quenching. The gain medium of the excimer amplifier 150 cannot store energy from a single excitation pulse in the way that rare earth ions in solid-state laser's gain media can. Energy from the gain medium of the excimer amplifier 150 increases the energy of each pulse 201, 202, 203 as each pulse propagates through the excimer amplifier 150. The amplified beamlets 200 (indicated as outgoing amplified pulses 211, 212, 213) can be individually refocused onto re-collimation mirrors 221, 222, 223 and then given a corrective optical delay in order to achieve pulse superposition at the surface of the fusion target 300.

The second electron beams 160, can be provided in essentially one pump pulse having a duration between approximately or exactly 100 ns and approximately or exactly 300 ns. This pump pulse can provide transient gain in the excimer amplifier 150. A method of extracting laser energy for the whole duration of the electron beam pump pulse is to pass short laser pulses 201, 202, 203 through the excimer amplifier 150 staggered in a steady temporal sequence spanning the pump pulse duration or at least a portion of the pump pulse duration. These short pulses can then be given different optical path delays after passing through the excimer amplifier 150 so that they are synchronized upon arrival at the fusion target 300.

With reference to FIG. 3, three pulses 201, 202, 203 enter the excimer amplifier 150 at different angles and in a staggered time sequence. The pulses emerge amplified many times as amplified pulses 211, 212 and 213 which can be respectively re-collimated with collimating mirrors 221, 222 and 223 to arrive in synchronism at target 300. In practice, up to 100 or more beamlets 70 of pulses can pass through the excimer amplifier 150 when laser pulses of a few nsec are generated in order to perform fusion target compression and ignition.

Further realization of the invention will be apparent to those skilled in the art and such additional embodiments are considered to be within the scope of the following claims.

The hybrid laser amplifier system 5 can be implemented in various configurations, some of which are described in the following listing.
(1) A hybrid laser amplifier system in which low-energy front end components comprise diode-pumped solid-state lasers and high-energy amplifier elements comprise an electron-beam-pumped argon fluoride or krypton fluoride gain medium which hybrid laser amplifier system incorporates a transfer medium that facilitates the transfer of front end spatial and temporal optical pulse information into newly created excimer spontaneous emission beamlets for input to the high-energy amplifier elements.
(2) A hybrid laser amplifier system as in configuration (1) in which the transfer medium comprises an electron-beam-pumped mixture of argon and fluorine that generates di-argon fluoride excited state molecules.
(3) A hybrid laser amplifier system as in configuration (1) in which the transfer medium comprises an electron-beam-pumped mixture of argon, krypton, and fluorine that generates di-krypton fluoride excited state molecules.
(4) A hybrid laser amplifier system as in any one of configurations (1) through (3) in which an output of the diode-pumped solid-state lasers is frequency multiplied into a band centered at approximately 320 nm before injection into the transfer medium.
(5) A hybrid laser amplifier system as in configuration (4) in which the frequency multiplied output is divided by beam-splitting optical elements into a multiplicity of beamlets before injection into the transfer medium.
(6) A hybrid laser amplifier system as in configuration (5) in which the multiplicity of beamlets is injected in a parallel array of beamlets into the transfer medium.
(7) A hybrid laser amplifier system as in configuration (5) in which the multiplicity of beamlets is injected into the transfer medium having different angles between the beamlets.
(8) A method of generating a multiplicity of uncorrelated and unpolarized beamlets of excimer laser amplified spontaneous emission for injection into electron-beam-pumped excimer laser amplifiers to achieve energy extraction via angular multiplexing.
(9) A method of generating a multiplicity of uncorrelated and unpolarized beamlets of excimer laser amplified spontaneous emission via low-energy front end components comprising diode-pumped solid state lasers, frequency multiplication of their output, beam splitting, and injection of these beamlets into a transfer medium that facilitates the transfer of front end spatial and temporal optical pulse information into excimer spontaneous emission beamlets for input to electron-beam-pumped high-energy excimer laser amplifiers.
(10) A method of generating a multiplicity of uncorrelated and unpolarized beamlets of excimer laser amplified spontaneous emission via front end components comprising diode-pumped solid state lasers, frequency multiplication of their output, beam splitting and injection of these beamlets into an electron-beam-pumped excimer laser gas volume for dissociation of di-excimer fluoride molecules producing excimer spontaneous emission beamlets for input to electron-beam-pumped high-energy excimer laser amplifiers.

### Conclusion

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that inventive embodiments may be practiced otherwise than as specifically described. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

Unless stated otherwise, the terms “approximately” and “about” are used to mean within ±20% of a target (e.g., dimension or orientation) in some embodiments, within ±10% of a target in some embodiments, within ±5% of a target in some embodiments, and yet within ±2% of a target in some embodiments. The terms “approximately” and “about” can include the target. The term “essentially” is used to mean within ±3% of a target.

The indefinite articles “a” and “an,” as used herein, unless clearly indicated to the contrary, should be understood to mean “at least one.”

The phrase “and/or,” as used herein, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of” or “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” shall have its ordinary meaning as used in the field of patent law.

As used herein, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A hybrid laser amplifier system comprising:
a diode-pumped solid-state laser to emit pulsed laser radiation;
a frequency multiplier optically coupled to the diode-pumped solid-state laser to convert a wavelength of the pulsed laser radiation to a first wavelength of first optical pulses;
a transfer medium optically coupled to the frequency multiplier and arranged to receive the first optical pulses and output second optical pulses; and
an electron-beam-pumped excimer amplifier optically coupled to the transfer medium and arranged to receive the second optical pulses and output amplified optical pulses, wherein:
the transfer medium converts a first wavelength of the first optical pulses to a second wavelength of the second optical pulses that will experience gain in the electron-beam-pumped excimer amplifier; and
the transfer medium transfers a spatial intensity profile and temporal pulse duration of the first optical pulses to the second optical pulses.

2. The hybrid laser amplifier system of claim 1, wherein the transfer medium comprises an electron-beam-pumped mixture of argon and fluorine that generates di-argon fluoride excited state molecules.

3. The hybrid laser amplifier system of claim 1, wherein the transfer medium comprises an electron-beam-pumped mixture of argon, krypton, and fluorine that generates di-krypton fluoride excited state molecules.

4. The hybrid laser amplifier system of claim 1, wherein the second optical pulses comprise amplified spontaneous emission.

5. The hybrid laser amplifier system of claim 1, wherein the frequency multiplier comprises a nonlinear optical crystal.

6. The hybrid laser amplifier system of claim 1, wherein the first wavelength is in a range from 300 nm to 400 nm.

7. The hybrid laser amplifier system of claim 1, further comprising:
at least one optical element optically coupled to the frequency multiplier to divide an output beam from the frequency multiplier into a plurality of beamlets containing the first optical pulses.

8. The hybrid laser amplifier system of claim 7, wherein the plurality of beamlets are incident on the transfer medium oriented parallel with respect to each other.

9. The hybrid laser amplifier system of claim 7, wherein the plurality of beamlets are incident on the transfer medium oriented at different angles with respect to each other.

10. The hybrid laser amplifier system of claim 7, wherein a bandwidth of the second optical pulses is between approximately or exactly 3 THz and approximately or exactly 15 THz.

11. The hybrid laser amplifier system of claim 1, further comprising at least one optical element to direct the amplified optical pulses to a same target.

12. A method of producing pulses of amplified spontaneous emission for amplification by an excimer amplifier, the method comprising:
emitting, by a diode-pumped solid-state laser, pulsed laser radiation;
receiving, by a transfer medium optically coupled to the diode-pumped solid-state laser, first optical pulses produced by the pulsed laser radiation;
converting, by the transfer medium, the first optical pulses at a first wavelength to second optical pulses at a second wavelength that will experience gain in the excimer amplifier; and
transferring, by the transfer medium, a spatial intensity profile and temporal pulse duration of the first optical pulses to the second optical pulses.

13. The method of claim 12, wherein the transfer medium comprises an electron-beam-pumped mixture of argon and fluorine that generates di-argon fluoride excited state molecules.

14. The method of claim 12, wherein the transfer medium comprises an electron-beam-pumped mixture of argon, krypton, and fluorine that generates di-krypton fluoride excited state molecules.

15. The method of claim 12, wherein the converting comprises producing the second optical pulses by amplified spontaneous emission.

16. The method of claim 12, further comprising:
converting, with a frequency multiplier optically coupled to the diode-pumped solid-state laser, a wavelength of the pulsed laser radiation to the first wavelength of the first optical pulses.

17. The method of claim 16, wherein the first wavelength is in a range from 300 nm to 400 nm.

18. The method of claim 16, further comprising:
dividing, with at least one optical element that is optically coupled to the frequency multiplier, an output beam from the frequency multiplier into a plurality of beamlets containing the first optical pulses.

19. The method of claim 18, further comprising:
optically directing the plurality of beamlets such that they are incident on the transfer medium oriented parallel with respect to each other.

20. The method of claim 18, further comprising:
optically directing the plurality of beamlets such that they are incident on the transfer medium oriented at different angles with respect to each other.
